(19) United States
(12) Patent Application Publication
(10) Pub. No.: US 2013/0057538 A1
(43) Pub. Date: Mar. 7, 2013

(54) Method for providing a rendering of the respiratory tract of a human or animal patient during or after an intervention

(71) Applicants: Janina Beilner, Shanghai (CN); Hui Ye, Shanghai (CN)

(72) Inventors: Janina Beilner, Shanghai (CN); Hui Ye, Shanghai (CN)

(21) Appl. No.: 13/307,369

(22) Filed: Nov. 30, 2011

Related U.S. Application Data
(60) Provisional application No. 61/531,755, filed on Sep. 7, 2011.

(51) Int. Cl. G06T 15/00

(52) U.S. Cl. 345/419

(57) ABSTRACT

A method for rendering a respiratory tract of a patient during an intervention is proposed. During the intervention, a catheter is introduced into the respiratory tract. A 3D image data record is obtained both using an X-ray angiography apparatus and also using a computed tomography system respectively. These 3D image data records are combined to obtain a rendering, in which both the advantages of the good mapping of structures by the computed tomography unit and those of the current rendering respectively, for example in respect of the position of the catheter, by the X-ray angiography apparatus are utilized. Optionally a further combination with images from an endoscope is also possible.

### CROSS REFERENCE TO RELATED APPLICATIONS

The present application claims the benefit of a provisional patent application filed on Sep. 7, 2011, and assigned application No. 61/531,755, which is incorporated by reference herein in its entirety.

### FIELD OF INVENTION

The invention relates to a method for providing a rendering of the respiratory tract of a human or animal patient, when the patient is undergoing an intervention; for example a stent is introduced into a respiratory vessel.

### BACKGROUND OF INVENTION

The respiratory tract of the human or animal patient is to be imaged in particular with the aid of X-ray radiation. The problem arises here that as a respiratory organ the lung and also the airways can only be seen with a very low level of contrast in X-ray images.

However computed tomography can be used to obtain very informative X-ray image data records. To this end a plurality of 2D image data records are recorded and a 3D image data record is calculated from these. A 3D image data record is a data record of gray-scale values, which are assigned to individual volume elements in the space taken up by the imaged object, and a measure of the attenuation of X-ray radiation in the region of this volume element due to the image object.

During this intervention it is not possible to use a complex computed tomography device, because the computed tomography unit obstructs the treating physician or conversely the treating physician gets in the way of the device.

During interventions what is known as an X-ray angiography apparatus is used as an X-ray image recording apparatus. An X-ray angiography apparatus features an X-ray C-arm with an X-ray tube and an X-ray radiation detector, the X-ray C-arm being rotated around the patient. A 2D X-ray image data record is then obtained in a plurality of positions, separated from one another by rotation, and a 3D image data record can then be calculated in turn from a plurality of such 2D X-ray image data records. Because of its similarity to computed tomography, this is also referred to as “Dyna CT®”, where “Dyna” stands for dynamic and “CT” for computed tomography. However images with an adequate contrast level cannot be rendered with the aid of an X-ray angiography apparatus.

The problem now arises that when a catheter for example is inserted with a stent into the respiratory tract, it is important to know where in the respiratory tract the catheter is located at any time. The 3D image data records obtained from the patient with the catheter using the X-ray angiography system are however not sufficiently good to offer the treating physician adequate assistance.

### SUMMARY OF INVENTION

The object of the invention is to specify a method, with the aid of which the treating physician can obtain better visual assistance.

The object is achieved by a method with the features claimed in the claims.

According to the invention therefore a first 3D image data record of the respiratory tract is obtained independently of the intervention using a computed tomography unit, which in the manner known per se comprises an X-ray tube and an X-ray radiation detector, which are rotated around the patient. This first 3D image data record is preferably obtained before the intervention.

Also in the inventive method a second 3D image data record of the respiratory tract is obtained during the intervention using an X-ray angiography apparatus, which comprises an X-ray C-arm with an X-ray tube and an X-ray radiation detector, which is rotated around the patient. In a last step a rendering is provided using image data from both the first image data record and the second image data record.

The invention utilizes methods for calculating or generally generating combined image renderings from different 3D image data records. In particular the high image quality of the first 3D image data record obtained with the aid of the computed tomography unit can be combined with the current view of the patient in a specific situation according to the second 3D image data record. For example the catheter can be clearly identified in the second 3D image data record, having not been visible at all in the previously recorded first 3D image data record, as said catheter is only introduced during the intervention. This allows the location of the catheter to be assigned precisely to the structures of the respiratory tract shown in the first 3D image data record.

One possible method for providing such combination image data records is to combine the first and second 3D image data records using a registering step, or what is known as locationally and dimensionally correct assignment, in which an mapping rule from one image data record to the other is defined, thereby forming a 3D combination image data record. The rendering is then provided based on the 3D combination image data record.

The rendering provided based on the 3D combination image data record can be a 2D rendering, specifically a 2D sectional rendering, which has to be calculated, or a 2D projection rendering, which simulates an X-ray image and also has to be calculated.

However the rendering can essentially also have a three-dimensional attribute, for example a rendering known as a “volume rendering”.

Since with the aid of computed tomography the first image data record allows a precise analysis of the respiratory tract, what is known as a branch image can be rendered, for example in conjunction with a 3D rendering of the walls of the vessel walls of the respiratory tract and bronchial tubes or even alone. A branch image shows individual vessel strands, with other vessel strands branching off from branch-off points, etc. Such branch images are known from the rendering of the blood vessels of a patient and in the present instance precisely the same computation methods as those used to obtain a branch image can also be used to obtain a branch image of the respiratory tract. Automatic identification of the respiratory tract in particular is necessary for this purpose.

In one preferred embodiment of the inventive method a plurality of second 3D image data records of the respiratory tract is obtained during different phases of the intervention and a rendering is provided respectively using image data from the first image data record and the respective second image data record. Particularly if the first image data record was recorded prior to the intervention, a plurality of renderings can be provided in sequence, so that for example the treating physician can track how the catheter is gradually introduced into the lung.

In a further aspect of the invention image data is also obtained during the intervention using an endoscope and this image data is also included in a or the rendering. In the present instance therefore image data obtained using the endoscope is combined with image data from the first and second 3D image data records. It is also possible to provide an additional rendering in the form of a combination of image data from the endoscope with image data from either the first or second 3D image data record. This concept can also be implemented separately, independently of the method claimed in claim 1.

In one preferred embodiment of the inventive method the first and/or second 3D image data record is used to calculate a 2D image data record, which simulates the view of an endoscope. This calculated 2D image data record is then combined with the image date obtained using the endoscope. It is therefore possible to combine the high-quality images from the first 3D image data record and/or the current images from the second 3D image data record with the endoscope images to obtain a rendering which improves the view of the endoscope to some extent.

The inventive method in all its aspects therefore provides particularly good assistance for the treating physician during an intervention.

### BRIEF DESCRIPTION OF THE DRAWINGS

The invention is described in more detail below with reference to a drawing, in which:

FIG. 1 shows an X-ray angiography device with a human patient,

FIG. 2 shows a schematic diagram of the components of a computed tomography unit with a human patient, and

FIG. 3 shows a flow chart to explain one embodiment of the inventive method with optional embodiments.

### DETAILED DESCRIPTION OF INVENTION

An X-ray angiography system designated as a whole as 100 is used during an intervention on a patient 10. The aim here is in particular to render the airways 12 and lung 14 of the patient 10 with the aid of X-rays. To this end the X-ray angiography system 100 has an X-ray radiation source 16 and an X-ray radiation detector 18, which are disposed on a C-arm 20 of a six-axis buckling arm robot 22. A control facility 24 activates the other components of the X-ray angiography system 100.

A computed tomography system 200 similarly features an X-ray radiation source 26 and an X-ray radiation detector 28, control taking place by means of a control facility 30.

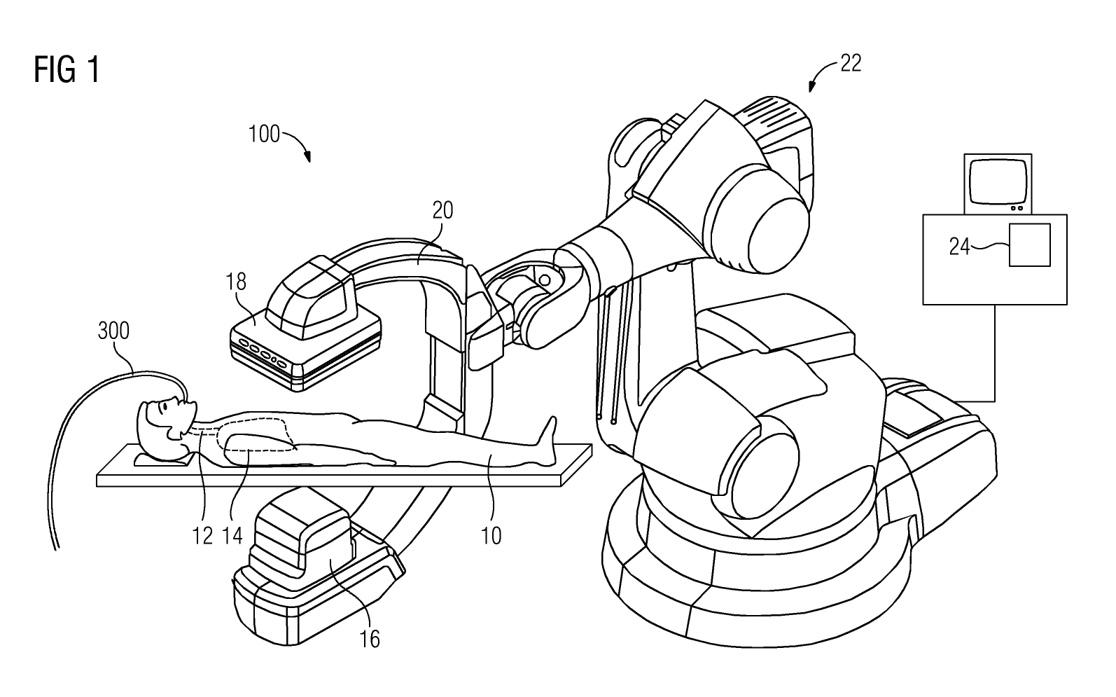

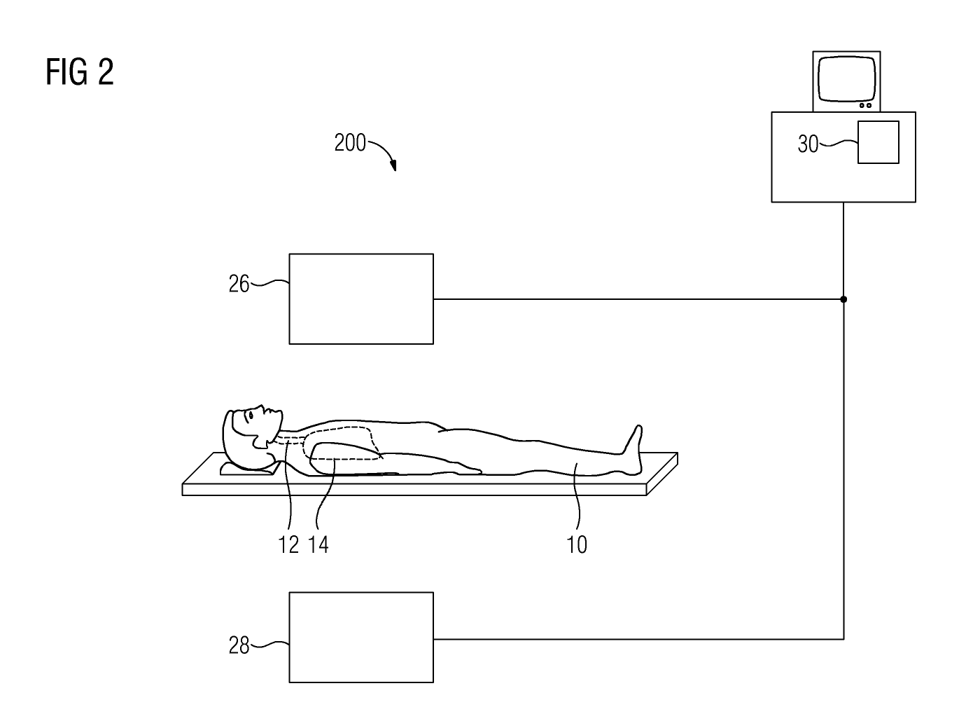

In the present invention both the computed tomography device 200 from FIG. 2 and the X-ray angiography apparatus 100 from FIG. 1 are used.

In a pre-intervention step, before the patient is treated, said patient is placed according to FIG. 2 in the computed tomography unit 200 and in step S10 a 3D image data record is obtained in the manner known per se with the aid of the computed tomography unit (“3D CT”).

For interventional treatment, during which for example a catheter is to be introduced into the airways 12 or lung 14 of the patient 10, this latter is moved to the X-ray angiography apparatus 100 (according to FIG. 1), where a sequence of 2D X-ray images is recorded in step S12, with a 3D image data record being calculated (“3D Dyna CT®”) therefrom. A first 3D image data record has therefore been obtained in step S10 and a second 3D image data record has been obtained in step S12. These two image data records are now registered with one another. During registering a locationally and dimensionally correct assignment is calculated, in other words a mapping rule from one image data record to the other image data record. Registering allows a merging of the two 3D image data records to provide a combination 3D image data record in step S14.

A rendering is then available in step S16 based on the merged 3D image data record. The rendering can be either two-dimensional, see S18, it being possible to calculate sectional images or projection images for example or in step S20 the rendering can also be three-dimensional, containing for example what is known as “volume rendering”. Alternatively or additionally a branch image can be rendered. This requires an intermediate step S22 of identifying the respiratory tract by automatic image recognition based on the combination image data record obtained in step S14. Identification of the respiratory tract can take place in the same way as the known identification of blood vessels.

Optionally in step S24 it is possible to return to step S12 and obtain a further second 3D image data record with the aid of the X-ray angiography apparatus 100. This is useful particularly if a catheter is to be advanced further still, using image monitoring.

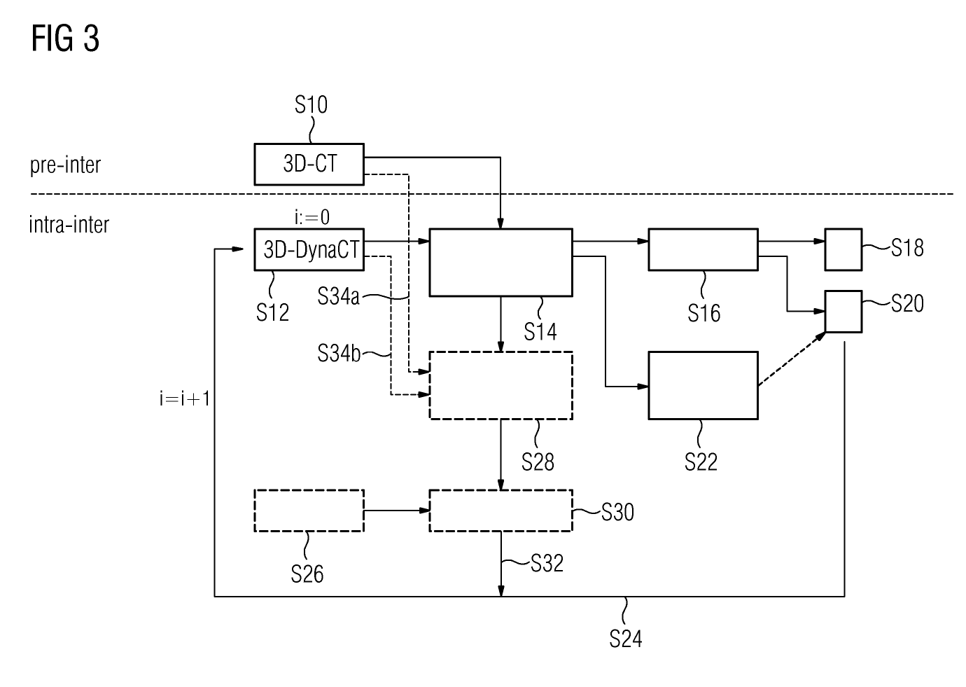

Another possibility is to introduce an endoscope 300 as shown in FIG. 1 into the patient and use this to obtain images, see step S26. The combination image data record calculated in step S14 can now be used to calculate a two-dimensional rendering in step S28, which corresponds exactly to the image shown by the endoscope. The endoscope image and the 2D rendering can then be overlaid in step S30, to provide a further rendering. Overlaying with the rendering from step S16 is a possible option here (not shown in FIG. 3).

After overlaying it is possible according to step S32 to return to step S12, which can take place at the same time as step S24.

The illustrated method provides the treating physician with particularly good assistance, as the high-quality images obtained prior to the intervention with the aid of the computed tomography device 200 in step S10 are combined respectively with current images, which show for example the position of the catheter particularly clearly, it being possible by calculating the combination image data record in step S14 for the position of the catheter to be assigned particularly precisely to body vessel structures, because the data from the first 3D image data record is also included in the combination image data record.

Endoscopy can also be used to create additional rendering options. As an alternative to the previously illustrated method the endoscopy in step S26 can also be combined just with the recording of a single 3D image data record, with either the image data record from the computed tomography device 200 being used in step S34a or alternatively the second 3D image data record from this X-ray angiography apparatus 100 being used in step S34b. The step of registering in step S14 would then not be necessary to obtain the overlaid image in step S30.

1. A method for providing a rendering of a respiratory tract of a patient during or after an intervention, comprising:
obtaining a first 3D image data record of the respiratory tract independently of the intervention using a computed tomography unit rotated around the patient, wherein the computed tomography unit comprises a first X-ray tube and a first X-ray radiation detector;
obtaining a second 3D image data record of the respiratory tract during the intervention using an X-ray angiography apparatus rotated around the patient, wherein the X-ray angiography apparatus comprises an X-ray C-arm with a second X-ray tube and a second X-ray radiation detector; and
providing the rendering using a first image data from the first image data record and a second image data from the second image data record.

2. The method as claimed in claim 1,
wherein a 3D combination image data record is obtained by combining the first and the second 3D image data records with registration of each other, and
wherein the rendering is provided based on the 3D combination image data record.

3. The method as claimed in claim 2, wherein the rendering comprises a 2D sectional rendering or a 2D projection rendering.

4. The method as claimed in claim 2, wherein the rendering comprises a 3D rendering.

5. The method as claimed in claim 2, wherein the rendering comprises a branch image generated based on an automatic image recognition of the respiratory tract.

6. The method as claimed in claim 1,
wherein a plurality of second 3D image data records of the respiratory tract is obtained during different phases of the intervention, and
wherein the rendering is respectively provided using the first image data and a respective second image data from a respective second 3D image data record.

7. The method as claimed in claim 1,
wherein an endoscope is used to obtain a third image data, and
wherein the rendering is provided based on the first, the second and the third image data.

8. The method as claimed in claim 7,
wherein the first and/or the second 3D image data record is used to calculate a 2D image data, and
wherein the 2D image data simulates a view of the endoscope and is combined with the third image data.

9. The method as claimed in claim 1, wherein the first 3D image data record of the respiratory tract is obtained before the intervention.
